(19) United States
(12) Patent Application Publication
(10) Pub. No.: US 2022/0379983 A1
(43) Pub. Date: Dec. 1, 2022

(54) Connection System for Connecting a Small Vehicle to a Base Station

(71) Applicant: Waterman Charging System GmbH, Berlin (DE)

(72) Inventors: Helmut Kueckens, Berlin (DE); Martin Reinhold, Bremen (DE)

(21) Appl. No.: 17/765,459

(22) PCT Filed: Oct. 11, 2020
(86) PCT No.: PCT/EP2020/078525

§ 371 Date: Mar. 31, 2022

(30) Foreign Application Priority Data
Oct. 13, 2019 (DE) 10 2019 007 080.1
Dec. 17, 2019 (DE) 10 2019 008 753.4
May 26, 2020 (DE) 10 2020 114 118.1

(51) Int. Cl. B62H 3/02; B62H 5/00

(52) U.S. Cl. CPC B62H 3/02; B62H 5/003; B62H 2003/005

(57) ABSTRACT

A connection system (1) for connecting a small vehicle (3) to a base station (2), comprising a first locking part (20) for installation on the base station (2) or the small vehicle (3), having a first securing unit (21), a second locking part (30), for installation on the small vehicle (3) or the base station (2), having a second securing unit (31); wherein the first locking part (20) and the second locking part (30) are designed for connection to one another, wherein the first securing unit (21) is selectively switchable between a release state and a locked state, wherein the first securing unit (21) and the second securing unit (31) are designed, more particularly complementarily designed, so that separation of the interconnected first and second locking parts (20, 30) is prevented in the locked state.

### CROSS REFERENCE TO RELATED APPLICATIONS

This application is the U.S. national stage of International Application No. PCT/EP2020/078525, filed on 2020 Oct. 11. The international application claims the priority of DE 102019007080.1 filed on 2019 Oct. 13, the priority of DE 102019008753.4 filed on 2019 Dec. 17 and the priority of DE 102020114118.1 filed on 2020 May 26; all applications are incorporated by reference herein in their entirety.

### BACKGROUND

The invention relates to a connecting device for connecting a small vehicle to a base station.

Currently, so-called rental e-scooters/e-bikes are parked in large numbers in public traffic areas. These are often parked inappropriately, they can be found in trees and waterbodies and are sometimes parked in a way that obstructs traffic. It is to be expected that some municipalities will regulate this kind of rental much more strongly. In addition, due to improper handling for charging and parking, the average life of such vehicles is sometimes limited to a few months.

Users currently have no way to park their privately purchased small vehicles at public base stations and, in particular, to recharge them there.

### SUMMARY

It is therefore the object of the invention to provide an improved possibility for parking small vehicles, in particular in public spaces. This is solved by a device, arrangement and use according to the main claims; embodiments are the subject of the subclaims and the description. The stated features and advantages are comprehensively combinable between the disclosed device, arrangement and use.

In particular, the base station is a charging station, especially a public charging station. In addition, the base station is also suitable for isolated use, for example, of a hotel or for factory traffic in a factory premises.

### DETAILED DESCRIPTION

In one embodiment, locking can be performed by the momentum of the second securing part at the downward connection direction transferring the first securing unit or the securing body to its locking state. This transfer can thereby comprise both a rotational and a translational movement. A return spring can be tensioned during this process.

After the securing body has been transferred to the locking state, it can be secured, in particular locked, in this position by an actuator. For subsequent release, the actuator is removed from its securing position, in particular by an actuator arrangement. Removal of the second securing part from the first securing part can be assisted by the tensioned return spring.

In one embodiment, the particular feature is that the first securing unit, which can be selectively transferred between a release state and a locking state, is not attached to the vehicle but to the distal end (as viewed from the base station) of the securing cable.

In one embodiment, the identification of a vehicle that is connected to the base station via the connecting device takes place using wireless data communication. The vehicle transmits an identification signal wirelessly, which is received by the base station.

The base station may have a receiver unit for wireless communication, and/or an evaluation unit. The vehicle can have a transmitter unit for wireless communication. The wireless communication can take place via ZigBee or Bluetooth.

In particular, if several vehicles are connected to a base station, an individual vehicle can be assigned to a connecting device. For this purpose, the base station can perform a test power supply on a selected connecting device from several connecting devices. The vehicle connected to the selected connecting device can detect the test current and send a confirmation signal of the detected test current in combination with the identification signal, which in turn is detected by the base station. From this, the base station can determine which vehicle from a plurality of vehicles within receiving range is connected to a selected connecting device.

### BRIEF DESCRIPTION OF THE DRAWINGS

The invention is explained in more detail below with reference to the figures; herein shows

FIG. 1 a suitable base station and suitable small electric vehicles, which can be connected to each other via a connecting device according to the invention;

FIG. 2 a wheel angle guide of the base station with parts of a small electric vehicles
a) in side view,
b) in top view;

FIG. 3 a connecting device according to the invention in one embodiment in two perspective views;

FIG. 4 the course of a connection direction of the first locking part during the connection process;

FIGS. 5-8 the connecting device according to FIG. 3 partially in side view during different phases of the connection process;

FIG. 9 a connecting device according to the invention in a further embodiment in side view in the connected state;

FIG. 10 a second locking part of the connecting device according to FIG. 9;

FIG. 11 a first locking part of the connecting device according to FIG. 9 in cross-section
a) in the release position,
b) in the locking state;

FIG. 12 a securing cable of the connecting device according to FIG. 9 in cross-section;

FIG. 13 a modification of the connecting device according to FIG. 9;

FIG. 14A a base station at a street lantern in one vehicle position;

FIG. 14B a base station at a street lantern in another vehicle position;

FIG. 14C a base station of a street lantern in a further vehicle position;

FIG. 15 two flowcharts for the process flow during a lending operation and a return operation;

FIG. 16 Locking parts of a connecting device according to the invention in a further embodiment in side view in individual representation;

FIG. 17 a locking part with an external release actuator;

FIG. 18 a variation of the securing cable shown in FIG. 12 with force transmission means.

### DETAILED DESCRIPTION OF THE PREFERRED EMBODIMENTS

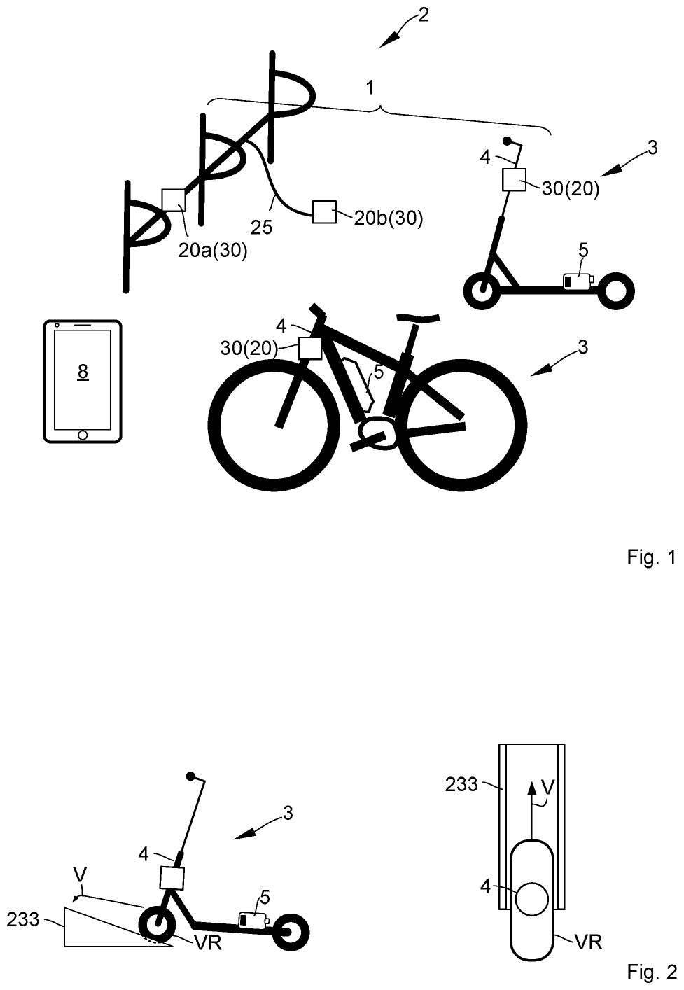

FIG. 1 shows a base station 2 and a small electric vehicle 3 with a rechargeable battery 5, which are connected to each other via a connecting device 1 according to the invention. The connecting device 1 comprises a first locking part 20 and a second locking part 30. By way of example, the first locking part 20 is permanently attached to the base station 2 and the second locking part 30 is attached to the small electric vehicle 3. Fixedly attached here means that the connection is not released during intended operation and precautions are taken to prevent unauthorized release. However, this does not preclude the possibility of disconnection for maintenance and assembly purposes or by force using various tools. In this case, the base station 2 is also a charging station for charging the battery 5 attached to the small electric vehicles.

Alternatively, the first locking part 20 may be fixedly attached to the small electric vehicle 3 and the second locking part 30 may be fixedly attached to the base station 2. This configuration is represented by the reference signs 20, 30 in parentheses.

The small vehicle can be a scooter (including motor scooter, pedal scooter, scooter) or a bicycle, each of which is in particular electrically operated. The small vehicle is in particular approved for transporting one person, maximum two persons. The small vehicle is in particular a two-wheeler.

In a first variant, the first locking part 20a is fixedly attached to the base station 2. To connect the two locking parts 20a, 30, the small electric vehicle 3 must be brought into a defined alignment with the base station 2.

In a second variant, the first locking part 20b is movably but securely connected to the base station 2 via a securing cable 25. To connect the two locking parts 20b, 30, the small electric vehicle 3 only needs to be positioned within a range of the base station 2, the range being limited by the length of the securing cable 25. The second locking part 30 is preferably positioned at a location on the small vehicle that is easily accessible to a user.

In the context of the present disclosure, the second locking part 30 or first locking part 20 may be understood as a component of the small vehicle 3 and the first locking part 20 or second locking part 30 may be understood as a component of the base station 2. Any adapters may be used to connect the respective locking part, for example, to a frame part of the vehicle.

Operation of the connecting device during a rental process and a return process can optionally be performed using an app installed on a mobile phone 8 for application.

FIGS. 2 to 8 describe a first embodiment of the first and second locking parts 20, 30. In particular, this is an embodiment of the first variant, especially without a security cable, in which the first locking part 20 is arranged in a fixed position on the base station 2.

The first locking part 20 comprises a first securing unit 21. The first securing unit 21 comprises a first securing body 211, exemplarily in the form of a securing pawl 211. The securing body 211 is movable, exemplarily rotatable, between a release position and a locking state. In the release position, the securing body 211 releases access to a securing receptacle 215; in the locking state, the securing body 211 closes access to the securing receptacle 215.

The second locking member 30 includes a second securing unit 31 having a locking latch 312. When the locking latch 312 is in its locking state, the locking latch 312 is received in the securing receptacle 215 and the securing body 211 is in its locking state. This is illustrated in FIG. 8.

The securing body 211 is held in its locking state by a control member 212. The control member 212 can be a rotary latch. FIG. 8 shows the control member 212 in its locking position. Here, the control member 212 interacts positively with the securing receptacle 215 or its latch recess 211a. By way of example, the control member 212 engages in a latch recess 211a on the securing body 211 and thereby prevents the movement of the securing body 211 out of the locking state.

The securing body 211 is actuated by an actuator arrangement 213, 214. The actuator arrangement comprises a release actuator 214 and an actuator spring 213. The control member 212 is held in the locking position (latch position) by the actuator spring 213 (spring force F) without energy having to be supplied for this (FIG. 8).

The release actuator 214 can selectively exert an actuating force S (shown dashed in FIG. 8), which counteracts the spring force F. The activated release actuator 214 consequently overrides the loading of the control member 212 by the actuating spring 213 and the control member 212 is guided out of the locking position. The securing body 211 can then be removed from the securing receptacle 215 by lifting the steering rod 4 slightly.

The connection of the vehicle to the base station first starts with a rough alignment of the second locking part 30 to the first locking part 20. For this purpose, the base station 2 is equipped with a wheel angle guide 233, which is shown in FIG. 2. Through this, the front wheel VR of the vehicle 3 can be aligned parallel to the connection direction V. The wheel angle guide 233 can have a suitable lateral guide, in particular similar to a front wheel support of a bicycle parking system. Sufficient clearance should be provided to allow the vehicle 3 to be further easily displaced in the connection direction V. The wheel angle guide 233 brings the steering rod 4 and thus the second locking part 30 into an alignment with the first locking part 20, in which further guidance is ensured.

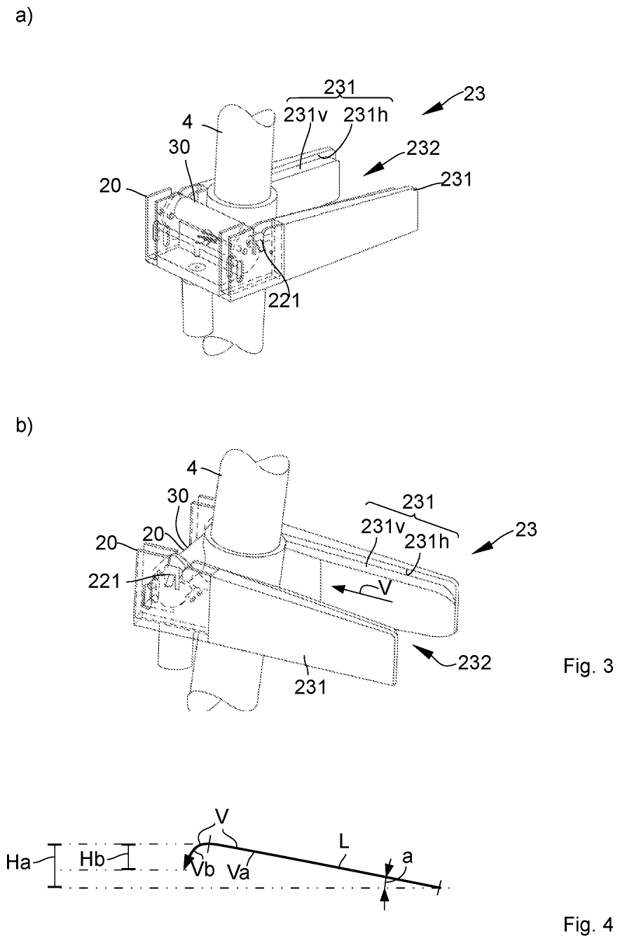

For further guidance, the first locking part 20 comprises a guide arrangement 23, by means of which a second guide member 33 (see FIG. 6) of the second securing unit 31 can be guided in a defined manner during the connecting process. In particular, the guide arrangement 23 comprises two guide rails 231 running parallel to one another, which define a steering rod receiving space 232 located therebetween (FIG. 3). During the connection process, a section of the steering rod 4 of the small vehicle 3 is thus held between the guide rails 231. The guide rails 231 can in principle be of multi-part design and define a connection direction V along which the guide member 33 is guided along the guide rail 231.

In particular, the guide rails 231 each comprise a horizontal guide surface 231h and a vertical guide surface 231v. These surfaces guide the guide member 33 horizontally transverse to the connection direction V and vertically in a defined manner. The horizontal guide surface 231h as well as the vertical guide surface 231v do not have to be aligned exactly horizontally and vertically, respectively; however, the surfaces ensure a horizontal and vertical alignment of the guide member 33, respectively. Using a suitable inclined surface, the horizontal guide surface 231h as well as the vertical guide surface 231v could also be formed by a common guide surface.

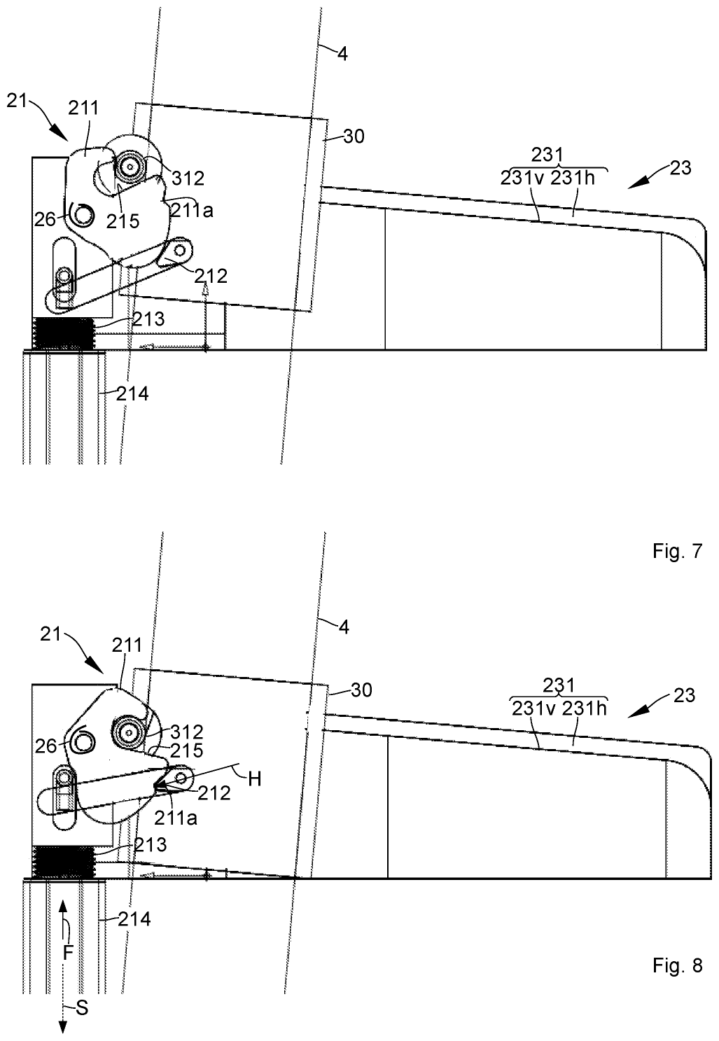

FIG. 4 shows the course of the connection direction V. Along a first rail section 231a (FIG. 6), the connection direction V has a first rising section Va, which forms an acute angle a greater than 0° with respect to the horizontal, preferably more than 10°. While the guide member 33 is guided on the rail along the connection direction, the vehicle 3 is thus slightly lifted at the front by the actuation of the user (FIG. 7 to FIG. 8). A first height difference Ha overcome by the first section Va is in particular at least 3 cm. In the process, the front wheel VR may lose traction. The rising rail course can also compensate for tolerances in the vertical positioning of the guide member 33 on the vehicle 3.

Along a second descending rail section 231b following in connection direction V (FIG. 6), the connection direction V has a second descending section Vb. This causes the vehicle to be urged downward by the weight force. A second height difference Hb overcome by the second section Vb is in particular smaller than the first height difference Ha, in particular in such a way that the vehicle continues to remain raised overall relative to a road surface. During the downward sliding along the second rail section 231b, the guide member 33 gets into the securing receptacle 215 (FIG. 6 to FIG. 7). During further downward movement (FIG. 7 to FIG. 8), the locking latch 312 is guided downward into the securing receptacle 215. Due to the potential energy released in the process, the securing body 211 is transferred to the locking state against a return spring 26. In addition, the return spring 26 is tensioned.

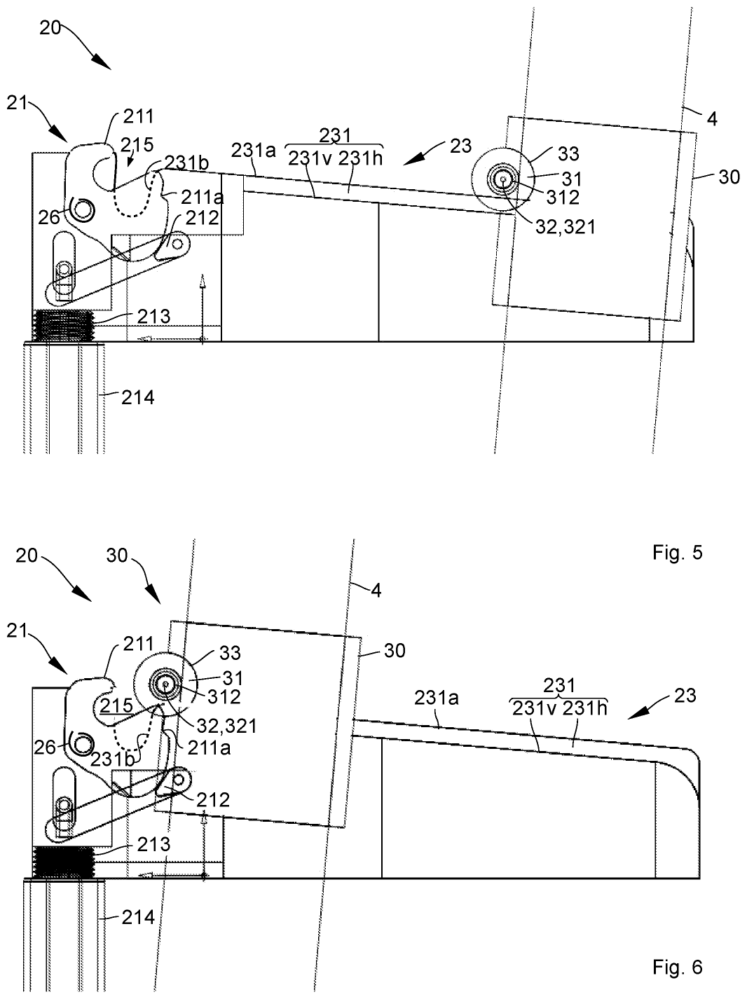

The release actuator 214 may be de-energized once the securing body is in its release position (FIGS. 5 to 7). The figures illustrate that the control member 212 is then out of the latch position by the securing body 211 itself. As soon as the locking state is reached, the control member 212, acted upon by the actuating spring 213, assumes the locking position.

In this example, the return spring 26 is a torsion spring. The return spring 26 can be dimensioned or preloaded in such a way that it compensates for the weight force by which the locking latch 312 is pressed downward. Then, both insertion and removal of the locking latch 312 from the securing receptacle 215 require at most a minor application of force by the user. Thus, as soon as the user removes the vehicle, the return spring 26 biases the securing body 211 into the release position. Since a return of the control member 212 to the locking position is now prevented by the securing body 211 itself, the actuating force S is dispensable and the release actuator is switched without energy.

The first locking part 20 has a first contact unit 22 with at least one or more spring contacts 221. The second closure part 30 has a second contact unit 32 which is of complementary design to the first contact unit 22. The second contact unit 32 comprises at least one or more first contact projections 321, which in particular protrude on both sides of the locking latch 312. In side view, the two first contact projections 321 are arranged approximately in the center of the securing receptacle 215. Thus, the position of the contact projections 321 is independent of the orientation of the handlebar (it is obvious that if the angle of the steering rod 4 were changed, the position of the contact projections 321 would not change). Via the contact units 22, 32, the charging current is transmitted between the base station 2 and the small electric vehicle 3 and, if necessary, a data exchange is carried out.

The connecting device includes a self-locking latch mechanism. For example, if a user attempts to forcibly remove securing body 211 from securing receptacle 215 by applying force, this will cause at least a slight rotation of securing body 211 (counterclockwise in FIG. 8). Then, latch recess 211a is pressed against control member 212, but this automatically increases an inhibiting force H that holds control member 212 in the locking position (FIG. 8). The stronger the user pulls, the greater the inhibiting force H becomes.

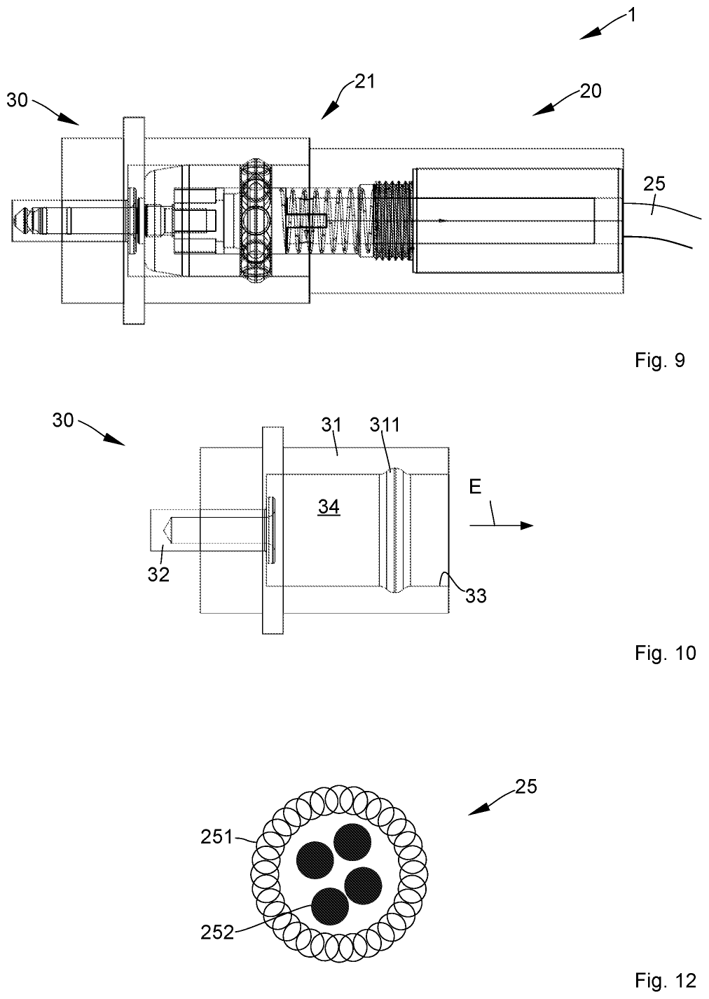

FIGS. 9 to 12 show a second embodiment of the first and second locking parts 20, 30. The first locking part 20 has a base body 24 designed as a plug; the second locking part 30 is designed as a sleeve with a receiving space 34, which receives the first locking part 20 in the coupled state. In particular, this is an embodiment of the second variant with securing cable.

The first locking part 20 comprises a first securing unit 21. The first securing unit 21 comprises at least one securing body 211, in this case a plurality of locking bodies 211. The locking bodies 211 are movable between a release position and a locking state.

The securing bodies 211 are arranged on a circumferential surface of the first base body 24. The securing bodies 211 are designed as radially movable securing balls, for example. With respect to a removal direction E, these securing bodies 211 are immovable. Radially to this removal direction E, the securing bodies 211 are movable in the release state (FIG. 11a); in the locking state (FIG. 11b), this radial movability is prevented and the securing bodies 211 assume a radially outer position.

The securing bodies 211 are held in the locking state by a control member 212. The control member 212 forces the securing bodies 211 radially outward. The control member 212 is in turn held in this position by an actuating spring 213 (spring force F) without the need to supply energy (FIG. 11b).

The first locking part 20 comprises a release actuator 214, which can selectively exert a positioning force S that counteracts the spring force F. The release actuator 214 is activated by the spring 213. When the actuator 214 is activated, the control member 212 is no longer acted upon by the positioning spring 213. The securing bodies 211 can now move freely in the radial direction and, if necessary, leave the locking state (FIG. 11a). Together with the actuating spring 213, the release actuator 214 forms an actuator arrangement 213, 214 for selectively transferring the first securing unit to and from the locking state.

In particular, an enable actuator 214 is operated with a supply voltage that can be identical to the supply voltage and/or charging voltage of the accumulator on the vehicle. Complex voltage converters thus become obsolete. In particular, small electric vehicles are operated with a supply voltage and/or charging voltage of 24V, 36V. 42V, 48V or 54V. This makes it possible to supply the power and control the release actuator from the charging station or even from the small electric vehicle using an additional electrical contact.

The second locking part 30 comprises a second securing unit 31. For this purpose, the receiving space 34 is provided with an annular groove 311 on an inner circumferential surface, which is aligned coaxially with the removal direction E. The annular groove 311 is formed in the receiving space 34. When the securing bodies 211 are in their locking state, they project at least partially into the annular groove 311 (FIG. 10), preventing the first locking part 20 from being removed from the second locking part 30.

The first locking part 20 has a first contact unit 22, which has the shape of a jack plug or a socket, for example. The second locking part 30 has a second contact unit 32 which is complementary to the first contact unit and has the shape of a jack socket, for example. Other types of plug connection can also be used for electrical contacting, for example the arrangement of the jack or socket on the two locking parts can be interchanged. The charging current is transmitted between the base station 2 and the small electric vehicle 3 via the contact units 22, 32 and, if necessary, a data exchange is carried out. Further contact points can be provided for data exchange, in particular for identification by means of an EEPROM.

The connecting device 1 presented in FIGS. 9-12 is particularly suitable for use in the second variant with securing cable 25. In such an application, the securing cable 25 is permanently connected to the base station 2 during operation and is not removed from the base station (at most for maintenance or replacement purposes). In the embodiment shown in FIG. 9, the first locking part 20 is located at that end of the securing cable 25 which is routed to the small electric vehicle 3 and is connected there to the second locking part 30. The second locking part 30 is attached to the small electric vehicle 3.

Thus, in contrast to known cable lock variants, it is provided that the locking mechanism with the release actuator 214 is attached to the movable end of the securing cable 25.

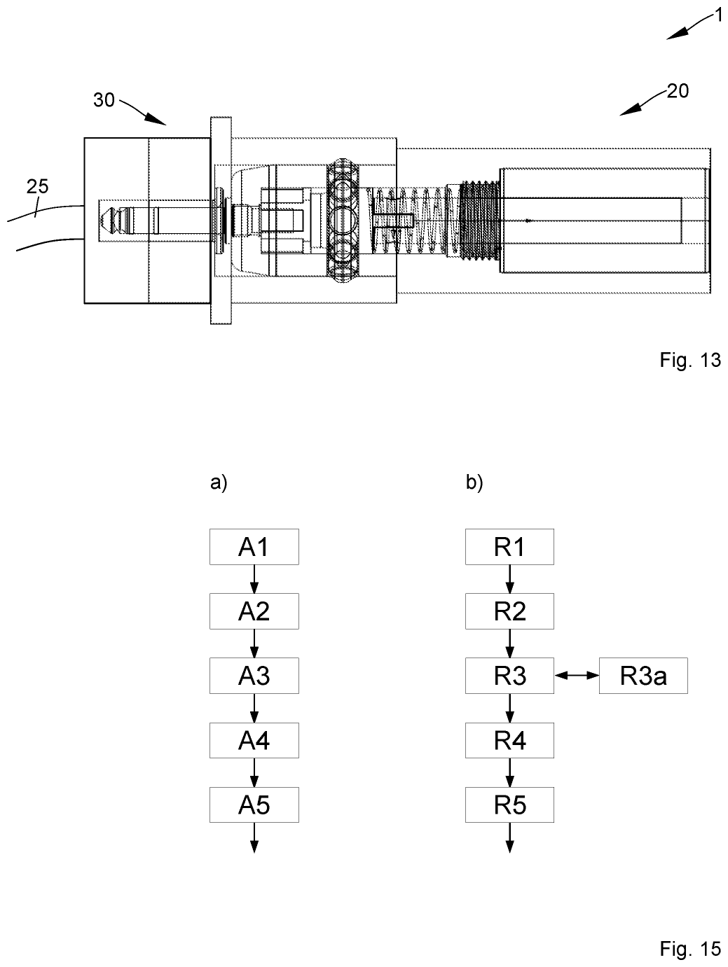

FIG. 13 shows a further development of the connecting device according to FIGS. 9 to 12. The details described for FIGS. 9 to 12 also apply to the device according to FIG. 9, unless otherwise stated below. What is different now is that the securing cable 25 is attached to the second locking part 30. The second locking part 30 is in particular the passive locking part and is in particular connected to the base station 2. The first locking part 20 with the switchable securing unit 21, in particular comprising the release actuator 214, is arranged on the vehicle 3 and is operated in particular by energy provided by the battery of the vehicle.

Such second securing units without a contact unit can be provided at low cost. They are particularly suitable for base stations at locations where an increased volume of returns is to be expected at times.

For example, near the stadium on a soccer league game day, a large number of drop-off locations are needed before the game begins. After the game, the vehicles are again rented out in greater numbers to take fans home. For the rest of the week, the high capacity is not needed. In this case, it may be useful for the base station to allow “locking only” for a very high number of vehicles, which can be implemented cost-effectively. Charging can then be limited to a small number of vehicle positions. Consequently, such a base station 2 (based on the base station shown in FIG. 1) may have second locking parts 30 with contact units 32 and, in addition, further second locking parts 30 without contact units 32. Importantly, however, the second locking parts 30 without contact units 32 are adapted to receive first locking parts 20 having first contact units 22. The space for receiving the contact units of the respective other locking part must therefore be provided.

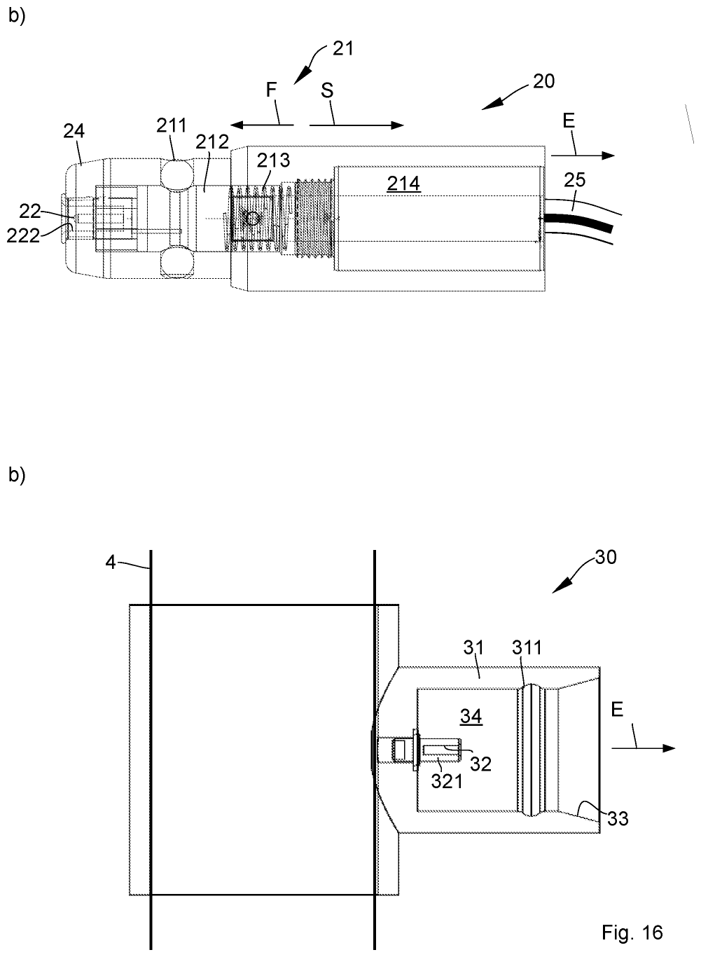

FIG. 16 shows a further variation of the connecting device according to FIGS. 9 to 12; in the following, only the deviations therefrom will be discussed. Here, the first contact unit 22 on the first locking part 20 does not protrude in a latch-like manner but is arranged within a contact socket 222 in the base body 24. The second contact unit 32 on the second locking part 20 has a contact projection 321 which is guided into the contact socket 222 during the connection of the two locking parts. The second locking part therefore has a shorter axial length; in addition, the first contact unit 22 is protected from external influences.

By way of example, the second locking part 30 is attached to the vehicle, in particular to its steering rod 4.

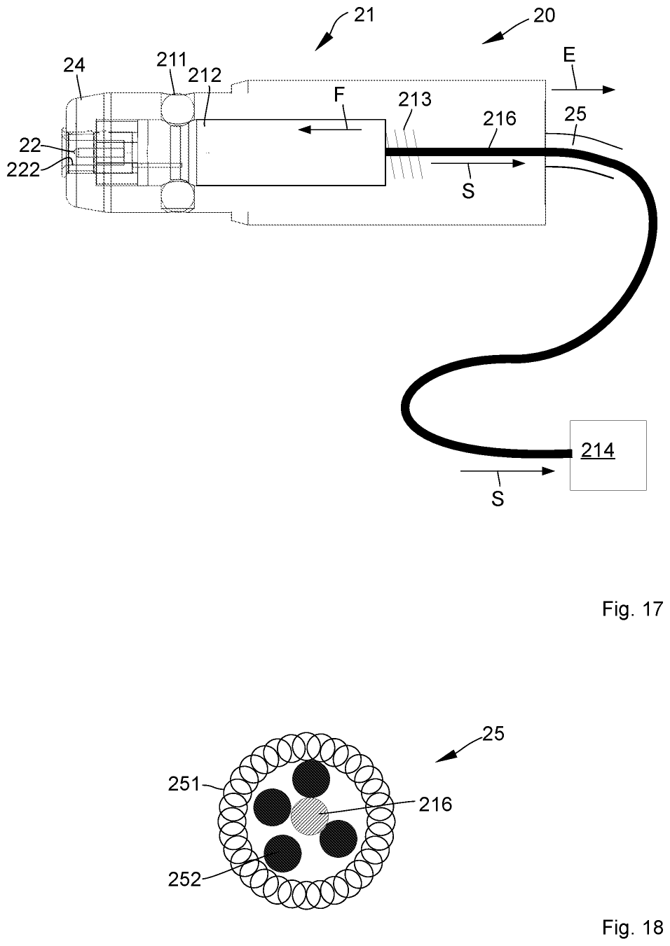

FIG. 17 shows a modification of the first locking part 20 according to FIG. 16; in the following, only the modifications thereto will be discussed. The modifications are in each case equally applicable to the embodiments of FIGS. 9, 11 and 13.

The release actuator 214 is arranged outside the locking part 20. The location of the release actuator 214 can be freely selected. In particular, the release actuator 214 can be arranged on a fixed part of the base station 2. A force transmission means 216 is provided, which transmits the actuating force S from the external release actuator 214 to the control member 212 in the first locking part.

The force transmission means 216 is guided in particular at least in sections in the securing cable 25. The power transmission means is shown in FIG. 17 as a cable pull, which can in particular be designed as a Bowden cable. An outer sheath of the cable pull is supported on the base body 24, while an inner pull cable is attached to the control member 212. When the cable pull is actuated, this causes a change in position of the control member 212 relative to the base body 24. The underlying operating principle of the power transmission is known from a bicycle brake.

Alternatively, the power transmission means can also be part of a hydraulic arrangement, similar to the power transmission in a hydraulic bicycle brake. In this case, the power transmission means in the securing cable 25 is the section of a hydraulic line.

By arranging the release actuator 214 outside the first locking part 20 and at a distance from the first locking part 20, the first locking part 20 can be small and lighter in design. Nevertheless, a large and reliably acting actuating force S can be provided since the release actuator 214 can be arranged at a location where small design and low weight are of less relevance.

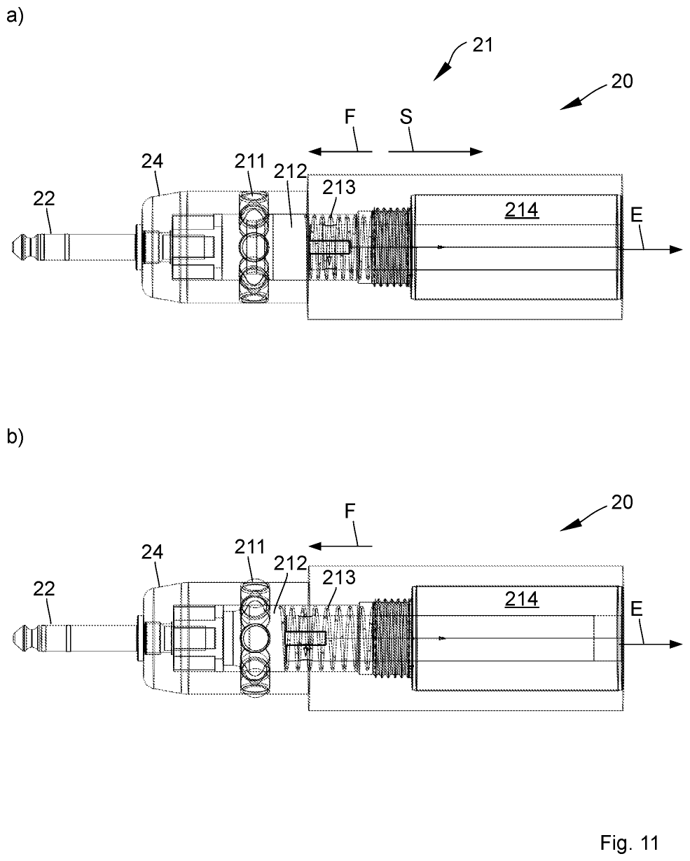

FIG. 18 shows the cross-section of the matching securing cable 25, which is based on the embodiment shown in FIG. 12. In addition, the securing cable 25 comprises at least a section of the force transmission means 216, which is arranged in particular within the armoring 251.

FIG. 12 shows a possible design of the securing cable 25 in cross-section. The securing cable has an outer armoring 251 which is intended to protect the securing cable 25 against vandalism. Within the armoring 251, various conductors 252 are provided to allow transmission of electrical power and/or data. The outer armoring can be designed, for example, as a gooseneck or as a metal protective hose (metal protective hose with plastic sheath).

Even though the invention has been described specifically for small electric vehicles in the present embodiments, it is also conceivable to secure conventional small vehicles such as rental bicycles or rental scooters (also without electric drive) using a connecting device of the type described. The corresponding contact units for current transmission are then dispensable.

In both variants, the release actuator 214 can be a linear solenoid that can selectively generate a positioning force S against the spring force F of the actuating spring, which is in particular greater than the spring force. However, another actuator can also be used to apply the force, in which case the linear solenoid is characterized by the fact that it is particularly favorable.

The vehicles can be identified as follows when parked at the respective base station.

When parking the vehicle with a charging process, the user identifies himself at the base station and/or at a first locking part, for example by scanning a QR code at the base station 2 or the locking part. If a charging process now also begins at this first locking part, the assignment between the first locking part and the vehicle can be established via the user's identification.

When the vehicle is later disconnected from the base station, it can be ensured that the correct first locking part is released.

When parking the vehicle without charging, the user can identify himself equally at the base station and/or at a first locking part. In this case, too, at least one short-term contact is made via the contact units, which establishes the association between the first locking part and the vehicle.

In one embodiment, which in particular can do without a contact unit (e.g. for rental bikes without electric drive), the user can identify himself equally at the base station and/or at a first locking part. The second contact unit 32 on the vehicle can be provided with a terminal resistor. Here, too, the first contact unit can detect as soon as an at least brief current flow occurs through the contact units.

As an alternative to identification via a detour with a user using the reading of the QR code, an electronic identification component can also be provided on the vehicle, e.g. an EEPROM (electrically erasable programmable read-only memory), which outputs a unique identifier (the identification information) on request. When coupling with the contact units, a unique assignment of the vehicle to the connected first locking part can thus be made directly between the vehicle and the base station 2 or first locking part. A reading unit can be provided at the base station which, when contact is established, can read out the contents and thus identification information of the small vehicle.

Very small EEPROMs are available on the market so that they can be easily integrated into the second locking part 30 on the vehicle.

When a small vehicle is attached to the base station via the connecting device, this process is registered in a database. For this purpose, identification information in the database is linked to the first locking part. As soon as the release of this vehicle is to be initiated at a later time, the first locking part to which the small vehicle is connected is again determined via this link. The release actuator of this locking part can then be specifically activated, releasing the vehicle.

The claimed connecting device is intended in particular for locking battery-powered rental vehicles to the base station. However, it is conceivable that vehicles with exchangeable batteries will also gradually be put into operation, making a charging process obsolete. In particular, for mixed operation, the present invention also makes it possible to connect vehicles without electric drive.

If the connecting device 1 according to one of the aforementioned figures does not support a charging function, the contact units 22, 22 in at least one of the locking parts can be dispensed with in the respective embodiments. However, it may be advantageous that the locking part which is attached to the base station has a contact unit so that vehicles with a charging function and vehicles without a charging function can be parked there equally.

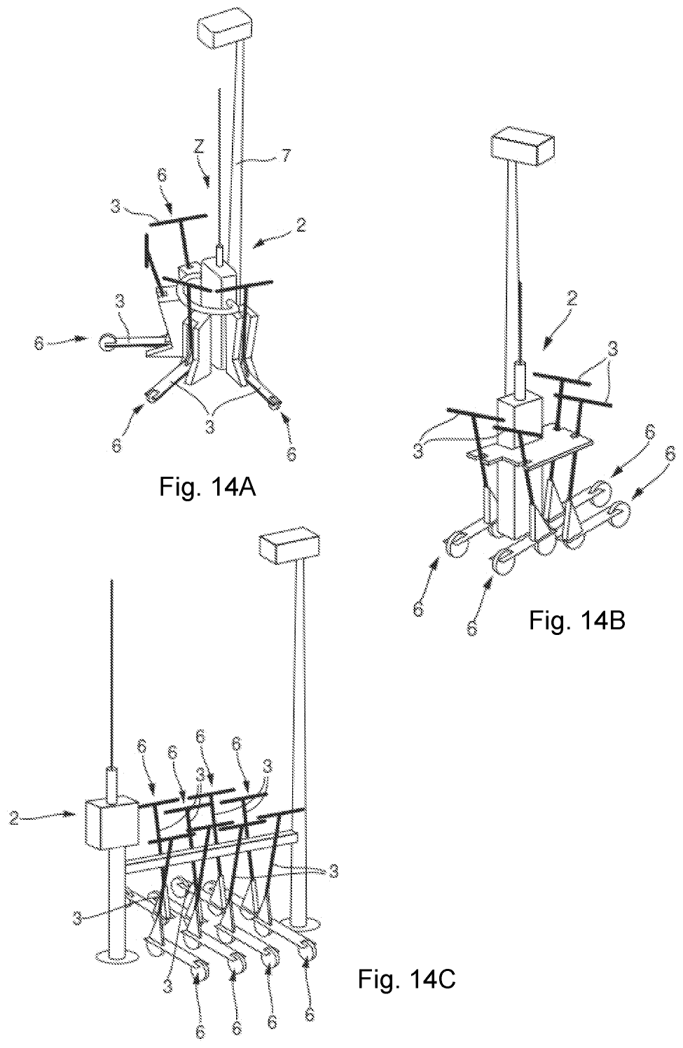

FIGS. 14a, 14b and 14c show further embodiments that can be combined with the previously described embodiments. In this case, the base station 2 has a number of vehicle positions 6 that are arranged, for example, at least in an arc, in particular in the shape of a circular arc (FIG. 14a) or also along an angular arc (FIG. 14b), around a center Z. Accordingly, the connected small electric vehicles 3 are also arranged in an arc around the center Z. The communication and power electronics of the base station 2 can be located in the center Z.

Alternatively or in combination, a street lantern 7 can be arranged in the center. In the variant shown in FIG. 14c, the miniature electric vehicles 3 are arranged on one side of the street lantern 7.

Using a street lantern 7, access to electrical power is made possible in a technically simple manner without having to lay new lines. Other earthworks can also be dispensed with in order to tap into power lines that have already been laid. The street lantern can also be used purely mechanically to act as a base frame for the individual parking or charging bays.

In particular, the vehicle positions are at least partially at a distance of less than 2 m from the street lantern 7.

FIG. 15a describes a possible procedure during a lending process.

In step A1, the user opens an app, e.g. on the mobile phone.

In step A2, the vehicle is identified. This can be done by the user scanning a code, in particular a QR code or RFID, an NFC code on the vehicle. Alternatively, this can also be done via matching position data, provided that this enables a unique assignment of a vehicle.

In step A3, the user confirms that the vehicle identified in step A2 is to be rented.

In step A4, the release actuator is actuated so that it is possible to separate the two locking parts from each other, and the two locking parts are separated from each other. It may be necessary for the user to actively support the separation process.

In step A5, the disconnection is detected by information technology. Here, a signal from a sensor on one of the locking parts can output a corresponding signal indicating that the locking parts are no longer connected to each other.

In parallel with one of steps 4 or 5, the vehicle is enabled for use. In particular, an immobilizer is deactivated. For this purpose, a message can be transmitted to the vehicle containing a release request.

In step A6, the use of the vehicle begins. In particular, the user drives off with the vehicle.

FIG. 15b describes a possible process sequence during a return operation.

In step R1, the user ends the use of the vehicle; he parks the vehicle at the base station. The two locking parts can already be connected to each other here.

In step R2 the app is opened.

In step R3, an “Exit” entry is made on the app. This can involve identifying the base station and/or an individual locking part that is connected to the base station and to which the locking part of the vehicle is to be connected. This can be done by scanning a code on the base station and/or on the locking part of the base station using the app.

Step R3 can comprise a substep R3a. In this step, it is communicated (in particular, the user is informed) to which of several locking parts at the base station the locking part on the vehicle is to be connected. In particular, this makes it possible to specifically assign either a locking part with charging function support and/or with contact unit or a locking part without charging function support and/or without contact unit to the connection process or to the vehicle.

In step R4 at the latest, the release actuator is held in a state in which it is possible to connect the two locking parts. At this point at the latest, the user connects the two locking parts to each other. However, the connection can also have been made earlier.

In step R5, the release actuator is in a state in which removal is not (no longer) possible. In this state, the release actuator can already be deactivated. The two locking parts can be locked by passive engagement without the release actuator having to be brought into different states. In addition, the connection is detected by information technology, in particular by a sensor.

Explicit identification of the vehicle can be dispensed with during the return process, especially if only one rented vehicle is associated with the user and/or the opened app at the time of return.

Alternatively, a unique identification of a respective returned vehicle can be made during the return process. This can be done as follows.

Both the base station and the vehicle are equipped with a Bluetooth module. When a vehicle comes close to the base station, communication is established between the base station and the vehicle via Bluetooth. In this way, the base station recognizes which vehicles are in the vicinity of the base station, as a unique identification is provided by the vehicle via Bluetooth in each case. If the charge level of a vehicle subsequently increases, it can be concluded that the identified vehicle is in the charging station. By selectively switching the charging current off and on again at an individual locking part of the base station (test current), an identified vehicle can be assigned to the respective locking part. Consequently, it can be determined which vehicle is attached to which locking part (this is advantageous if several vehicles are coupled almost simultaneously in the charging station). This identification can then also be used for billing the customer. Due to the optional reading of the charging status and wireless transmission, in particular via Bluetooth, and the current measurement at the respective locking part, the amount of electricity provided for the respective vehicle can be clearly determined.

For all embodiments, the power supply for the release actuator can be provided by the charging device at the base station. Alternatively, the power supply for the release actuator can be provided by the vehicle's rechargeable battery. If required, further electrical contacts can be provided on the locking parts to transfer the power supply for the release actuator from the first locking part to the second locking part or vice versa.

### LIST OF REFERENCE NUMERALS

1 connecting device
2 base station, in particular charging station
3 small electric vehicle
4 steering rod of small electric vehicle
5 battery
6 vehicle positions
7 street lantern
8 mobile phone
20 first locking part
21 first securing unit
211 securing body
211a latch recess
212 actuator control member
213 actuating spring
214 release actuator
215 securing receptacle
216 bowden cable
22 first contact unit
221 spring contact
222 contact socket
23 guide arrangement
231 guide rail
231v vertical guide surface
231h horizontal guide surface
231a,b sections of guide rail
232 steering rod receiving space
233 wheel angle guide
24 base body
25 securing cable
251 armoring
252 conductor
26 return spring
30 second locking part
31 second securing unit
311 annular groove
312 locking latch
32 second contact unit
321 contact projection
33 guide member
34 receiving space
S setting force of the actuator
F spring force of the actuating spring
E removal direction
V connection direction
Va first section
Vb second section
L length of first section
Ha vertical height difference of the first section
Hb vertical height difference of the second section
VR front wheel
a angle of the first section to the horizontal
Z center
A1-A5 procedural steps in the rental process
R1-R5 procedural steps in the return process

1. A connecting device (1) for connecting a small vehicle (3) to a base station (2), comprising
a first locking part (20) for attachment to the base station (2) or the small vehicle (3), having a first securing unit (21),
a second locking part (30) for attachment to the small vehicle (3) or the base station (2), having a second securing unit (31);
wherein the first locking part (20) and the second locking part (30) are designed to be connected to one another,
wherein the first securing unit (21) can be selectively transferred between a release state and a locking state,
wherein the first securing unit (21) and the second securing unit (31) are designed in such a way, in particular complementary to one another, that separation of the interconnected first and second locking parts (20, 30) is prevented in the locking state, comprising
a securing cable (25) for mechanically securing the small vehicle (3) to the base station (2),
characterized in that the securing cable (25) is fixedly connected to the first locking part (20),
wherein a securing body (211) and/or a control member (212) is attached to the first locking part (20), the first locking part (20) being firmly connected to the base station (2) via the securing cable (25).

2. (canceled)

3. (canceled)

4. (canceled)

5. The connecting device (1) according to claim 1,
characterized in
that a release actuator (214) for transferring the securing body (211) and/or the control member (212) out of the locking state is arranged outside of the first locking part (20), in particular is arranged remote from the first locking part.

6. (canceled)

7. The connecting device (1) according to claim 1,
characterized in
that the securing cable (25) has an outer armoring (251), in particular for protecting the securing cable (25) against vandalism;
and in that conductors (252) for transmitting electrical power and/or data are arranged inside the armoring (251).

8. The connecting device (1) according to claim 1,
characterized in
that the first locking part (20) has a first contact unit (22),
that the second locking part (30) has a second contact unit (32),
that the first and second contact units (22, 32) are designed, in particular complementary, to one another, in such a way that an electrical connection for transmitting a charging current and/or data is established between the base station (2) and the small vehicle (3).

9. (canceled)

10. The connecting device (1) according to claim 1,
characterized by
an actuator arrangement (213, 214) arranged for selectively transferring the first securing unit (21) to and out of the locking state.

11. The connecting device (1) according to claim 1,
characterized by
at least one securing body (211), which is in particular attached to the first of the locking parts (20) and/or is a component of the first securing unit (21),
wherein the securing body (211) can be selectively fixed in a locking state, in particular by means of the actuator arrangement (213, 214),
wherein the securing body (211) is adapted to hold the second shooting part (30) in coupled position with the first locking part (20) in the locking state.

12. The connecting device (1) according to claim 1,
characterized in
in that the connecting device (1) is designed to be self-locking,
in particular in that the connecting device (1) is designed in such a way that, when the securing body (211), in particular locked, is acted upon, in particular by means of an action by means of the second locking part (30), an inhibiting force (H) is generated out of the locking state, which inhibiting force urges the securing body (211) in its locking state.

13. The connecting device (1) according to claim 1,
characterized in
in that the actuator arrangement (213, 214)
comprises an actuating spring (213), set up to provide a spring force (F), the securing body (211) being acted upon at least indirectly in the locking state by means of the spring force (F),
comprises a release actuator (214), set up to selectively generate an actuating force (S) counteracting the spring force (F).

14. (canceled)

15. The connecting device (1) according to claim 1,
characterized in
in that a force transmission means (216), in particular a cable pull, in particular a Bowden cable, or in particular a hydraulic line of a hydraulic arrangement, is provided, adapted for transmitting the actuating force (S) from the release actuator (214) arranged outside the locking part (20) to the securing body (211) and/or control member (212) arranged inside the locking part, in particular the force transmission means (216) being guided at least in sections in a securing cable (25).

16. The connecting device (1) according to claim 1,
characterized by,
a guide arrangement (23) on one of the locking parts, in particular on the first locking part (30),
and a guide member (33) on the other of the locking parts, in particular on the second locking part (30),
wherein the guide arrangement (23) and the guide member (33) are formed relative to one another in such a way that, during a locking movement of the locking parts in particular along a connecting direction (V) of the locking parts (20, 30) towards one another, the second securing unit (31) comes into engagement with the first securing unit (21),
and in particular and/or where present the second contact unit (32) comes into electrically conductive contact with the first contact unit (22).

17. (canceled)

18. (canceled)

19. An arrangement comprising a small electric vehicle (3) and a base station (2), with a connecting device (1) according to claim 1.

20. The arrangement according to claim 19,
characterized in
that the first locking part (20) is fixedly attached to the base station (2) and the second locking part (30) is fixedly attached to the small electric vehicle (3).

21. The arrangement according to claim 19,
characterized in
that one of the locking parts is movably but securely connected to the base station (2) via the securing cable (25).

22. (canceled)

23. The arrangement according to claim 19,
wherein the base station (2) defines a plurality, in particular at least three, vehicle positions (6) at which a small vehicle (3) can be parked in
each case and can be connected to the base station via the connecting device,
wherein the vehicle positions
are arranged at least partially within a distance of less than 2 m from a street lantern (7), and/or
are arranged in an arc, in particular in the shape of a circular arc or in an angular shape, around a center (Z).

24. (canceled)

25. Use of a connecting device or arrangement according to claim 19 for connecting a small vehicle (3) to a base station (2).

26. Use according to claim 25, comprising the following method steps during a rental process:
(A1) initiating a rental process, in particular by calling up an app on a mobile terminal, in particular a mobile phone,
(A2) identifying a vehicle which is to be rented and which is connected with a locking part to on another locking part of the base station,
(A3) confirmation by the user, in particular by means of the app, that the identified vehicle is to be rented,
(A4) actuation of a release actuator on one of the locking parts, so that the locking part on the identified vehicle can be separated from a locking part on the base station,
(A5) information technological detection of the separation of the two locking parts, in particular by means of a sensor on one of the two locking parts, and/or release of the use of the identified vehicle.

27. (canceled)

28. (canceled)

29. (canceled)

30. (canceled)

31. An arrangement comprising a small electric vehicle (3) and a base station (2), with a connecting device (1);
the connecting device (1) adapted for connecting a small vehicle (3) to a base station (2) comprising
a first locking part (20) for attachment to the base station (2) or the small vehicle (3), having a first securing unit (21),
a second locking part (30) for attachment to the small vehicle (3) or the base station (2), having a second securing unit (31);
wherein the first locking part (20) and the second locking part (30) are designed to be connected to one another,
wherein the first securing unit (21) can be selectively transferred between a release state and a locking state,
wherein the first securing unit (21) and the second securing unit (31) are designed in such a way, in particular complementary to one another, that separation of the interconnected first and second locking parts (20, 30) is prevented in the locking state.

32. The arrangement according to claim 31,
wherein the base station (2) defines a plurality, in particular at least three, vehicle positions (6) at which a small vehicle (3) can be parked in
each case and can be connected to the base station via the connecting device.

33. The arrangement according to claim 32,
wherein vehicle positions (6) are arranged at least partially within a distance of less than 2 m from a street lantern (7).

34. The arrangement according to claim 32,
wherein vehicle positions (6) are arranged in an arc, in particular in the shape of a circular arc or in an angular shape, around a center (Z)
